(19) United States
(12) Patent Application Publication
(10) Pub. No.: US 2009/0210543 A1
(43) Pub. Date: Aug. 20, 2009

(54) System and Method for Subscription Resource Discovery

(76) Inventor: Jonathan Olsson, Uppsala (SE)

Correspondence Address: ERICSSON INC., 6300 LEGACY DRIVE, M/S EVR 1-C-11, PLANO, TX, 75024, US

(21) Appl. No.: 12/296,681

(22) PCT Filed: Apr. 12, 2006
(86) PCT No.: PCT/IB2006/000857

§ 371 Date: Oct. 10, 2008

(30) Foreign Application Priority Data
Apr. 20, 2006 (DK) PA 2006 00543

(51) Int. Cl. G06F 15/16

(52) U.S. Cl. 709/229

(57) ABSTRACT

A system and method for providing an end-user network with information regarding access network resources allocated to specific services. The access network includes a Resource Management System (RMS) for managing service bindings in the access network. A Resource Discovery Client (RDC) associated with the end-user network sends a resource discovery request to a Resource Discovery Server (RDS) associated with the access network. The RDS receives the resource discovery request and obtains service binding information from the RMS. The service binding information indicates access network resources that are allocated to specific services. The RDS then sends a response to the RDC, and includes the information regarding access network resources allocated to specific services. The RDC may send the information to user devices in the end-user network.

### TECHNICAL FIELD OF THE INVENTION

The present invention relates generally to communications networks, and in particular, to communications networks that provide different Quality of Service (QoS) levels to different subscribers or applications.

### DESCRIPTION OF RELATED ART

Market trends today show that end-users subscribe to an increased number of simultaneous network-based services. Newer services, such as IPTV and HDTV, require more resources than traditional services and often require stringent quality controls to ensure an acceptable end-user experience. The resource management task becomes more complex when several services are utilized in the end-user's home network, but even more so when multiple services are used on the same device.

In general, when a customer subscribes to a service from a service provider, a Service Level Agreement (SLA) is negotiated between the two parties that specifies the terms of the service. An SLA is a binding contract between a customer and a service provider that stipulates, among other things, the service to be delivered, the duration and cost of the service, and legal obligations.

In order for the SLA to be used in the network, it is mapped to one or several Service Level Specifications (SLS), which are applied as network policies. An SLS is a set of technical descriptions that specify in detail the service and the attributes and parameters that correspond with the SLA. These values are used when setting up a service session and deploying policies, or by a resource management system when reserving network resources.

Several studies have proposed solutions that suggest a resource management and admission control system that has greater control of network resource usage, availability, and service flows. Such a system would optimize the usage of scarce network resources and provide a combination of absolute and/or relative QoS.

A method has also been proposed by which resource negotiation over multiple resource domains provides end-to-end QoS for services traversing an ambiguous number of network operator domains. This is achieved through interfaces that allow resource and admission control systems to communicate.

These proposed resource and admission control solutions extend from the service provider to the last node in the operator network, usually an access node. In essence, the resource management system administers only the systems within this domain. Only within this domain are devices aware of the resources allocated to specific service flows.

The SLA negotiated between the end-user customer and the service provider provides an agreed-to QoS from the service provider to the customer premises. Resource management systems proposed today enforce these agreements to the last node in the operator's network. In the best scenario, the operator will deliver end-to-end absolute QoS to the user home network. The user home network, however, is unaware of the resources that are made available through the service subscription.

Devices between the access node and the user home network may access the delivered services, potentially pushing the available resources to the limit. For example, a customer may order a 5 Mbit connection from an ISP. This means that all devices utilizing that connection must share resources. The more devices that are connected, the less resources will be available to each device. There are currently no mechanisms in place in the home to prevent the misuse of these scarce resources.

Another problem associated with resource management and SLAs is service assurance. There are no mechanisms in place today that a home gateway can use to verify that a service agreement is upheld, and there is no mechanism for reporting a breach of the SLA if one is detected.

In the growing multi-service environment, there may be several services running in the customer premises, each with different characteristics and different amounts of resources allocated to them by a resource management system. This presents a unique resource distribution challenge that is not met by current solutions. For example, a user may subscribe to both a video service and an Internet service from two disparate service providers, each with a unique SLA that specifies different service parameters. The solutions today do not provide any means by which these services can be separated and treated differently when they are run on a single device. Therefore, the subscriptions cannot be used optimally.

Accordingly, there is a need for an improved system and method of managing network resources that overcomes the disadvantages of the prior art. The present invention provides such a system and method.

### SUMMARY OF THE INVENTION

The present invention is directed to a system and method by which user networks, and devices in the network, are made aware of resources allocated to specific services as per the agreements made between the end-user and service providers. As a result, applications can more efficiently utilize available resources. Additionally, the system may include a mechanism for measuring the delivered service level and for reporting a breach of the SLA if one is detected.

Thus in one aspect, the present invention is directed to a system for providing an end-user network with information regarding access network resources allocated to specific services. The access network includes a Resource Management System (RMS) for managing service bindings in the access network. The system includes a Resource Discovery Client (RDC) associated with the end-user network and a Resource Discovery Server (RDS) associated with the access network. The RDC sends a resource discovery request to the RDS. The RDS receives the resource discovery request and obtains service binding information from the RMS. The service binding information indicates access network resources that are allocated to specific services. The RDS then sends a response to the RDC, and includes the information regarding access network resources allocated to specific services.

In another aspect, the present invention is directed to a method of providing an end-user network with information regarding access network resources allocated to specific services, wherein the access network includes a Resource Management System (RMS) for managing service bindings in the access network. The method includes receiving by a Resource Discovery Server (RDS) associated with the access network, a resource discovery request from a Resource Discovery Client (RDC) associated with the end-user network; obtaining by the RDS, service binding information from the RMS, wherein the service binding information indicates access network resources that are allocated to specific services; and sending a response from the RDS to the RDC, the response including the information regarding access network resources allocated to specific services.

In yet another aspect, the present invention is directed to a Resource Discovery Server (RDS) associated with an access network for providing an end-user network with information regarding access network resources allocated to specific services, wherein the access network includes a Resource Management System (RMS) for managing service bindings in the access network. The RDS includes means for receiving a resource discovery request from a Resource Discovery Client (RDC) associated with the end-user network; means for obtaining service binding information from the RMS, the service binding information indicating access network resources that are allocated to specific services; and means for sending a response to the RDC, the response including the information regarding access network resources allocated to specific services.

### BRIEF DESCRIPTION OF THE DRAWINGS

FIG. 1 is a simplified block diagram illustrating an exemplary embodiment of a resource discovery system implemented between a user device and a Resource Management System (RMS) in an access network; and

FIG. 2 is a signaling diagram illustrating an exemplary signaling sequence when a Resource Discovery Client (RDC) associated with a user device requests resource information from a Resource Discovery Server (RDS).

### DETAILED DESCRIPTION OF EMBODIMENTS

The present invention is preferably implemented in an access network that includes a Resource Management System (RMS) for admission control, bandwidth brokering, policing, and enforcing absolute and/or relative QoS. The RMS separates and identifies service bindings (service flows) that exist between a customer and a service provider. Each service binding represents a transport relationship between the customer and the service provider, with assigned QoS and service attributes. These attributes represent a subset of the SLA.

The RMS utilizes the service bindings to apply policing rules in the access network. Policies that are implemented are based on SLSs derived from an SLA and are in place to enforce and uphold the terms of the agreement. In a multi-service, multi-provider environment, this separation of service bindings and application of proper policies is critical in assuring end-to-end QoS.

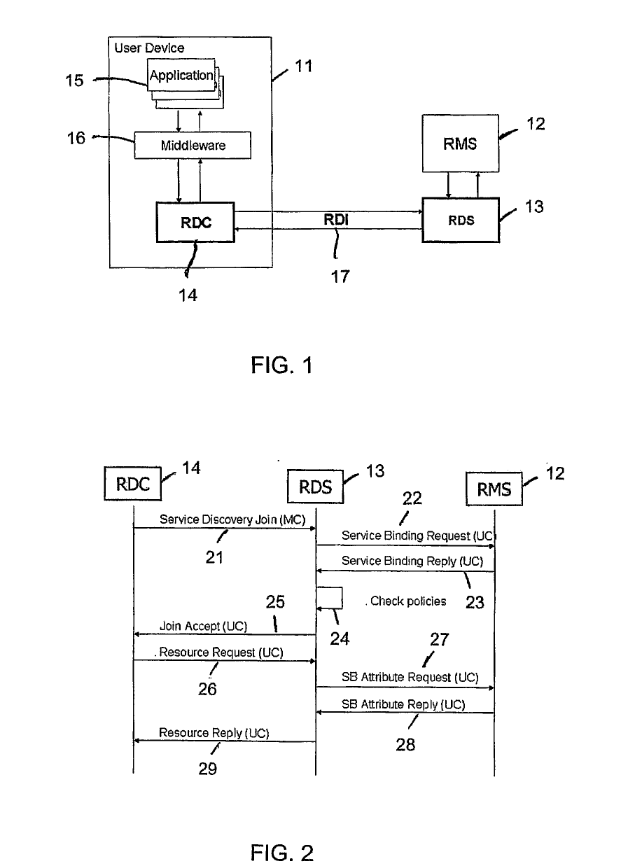

FIG. 1 is a simplified block diagram illustrating an exemplary embodiment of a resource discovery system implemented between a user device 11 and an RMS 12 in an access network. The present invention provides mechanisms enabling information about resource availability to be communicated to the user device in the customer premises through a resource discovery service. The resource discovery service is implemented through a Resource Discovery Server (RDS) 13 and a Resource Discovery Client (RDC) 14.

The RMS 12 resides at the edge of the access network where all services are aggregated. Thus, the RMS is aware of all of the service bindings that are active at any time, and manages them accordingly. Hosted by, or located adjacent to the RMS, is the RDS 13, which interacts with the RMS to obtain service binding information.

The RDS 13 interacts with the RMS 12 to perform the following functions:
Identification of a service binding;
Verification of a service binding;
Requesting attributes related to the service binding;
Receiving service resource updates; and
Authentication.

The RDS 13 handles requests from the customer premises for resource information pertaining to specific service bindings. The RDS performs the following tasks toward the customer premises:
Handling resource discovery join requests;
Receiving resource discovery requests;
Sending resource discovery replies;
Sending service resource updates; and
Authentication.

The RDS 13 may also define policies determining the frequency at which requests can be made. The RDS also caches previous requests in order to identify previous service bindings for faster response time.

The services provided by the RDS 13 may be a pay service, in which case the RDS collects accounting information that is forwarded to an accounting server. Since the network operator provides this service, the RDS may utilize mechanisms in the edge node to identify the origin of requests.

The RDC 14 manages interaction with the RDS 13. The RDC may be integrated with multiple user devices, such as a residential gateway, computers, setup boxes, and the like in the customer premises. Thus, the RDC may interface with various applications 15 directly or through middleware 16. Mechanisms in these devices may be used to query the RDC about available network resources, for example, on a network interface or VLAN.

The RDC 14 communicates requests to the access network and handles the interaction with the RDS 13 that replies. The RDC may authenticate the RDS in order to assure that the correct server was contacted. Authentication may not be necessary in a network where traffic is tunneled to the edge from the access node if it is assumed that the network provider is a trusted entity.

The RDC 14 may store resource information in order to provide relative information in response to requests made by the user device. The RDC may update this information within predefined time intervals or may receive update notifications from the RDS 13.

A Resource Discovery Interface (RDI) 17 connects the RDS 13 and the RDC 14. The RDI utilizes multicast messages to manage server discovery and utilizes unicast messages to handle information requests and responses between the RDC and the RDS. The RDI includes a set of request and reply control messages that are sent between the RDC and the RDS. A preferred protocol for this interface has qualities that make it lightweight, with little overhead.

FIG. 2 is a signaling diagram illustrating an exemplary signaling sequence when the RDC 14 requests resource information from the RDS 13. When the user device 11 boots, the RDC 14 is unaware of the IP address of the RDS 13 from which the RDC can obtain resource information. Therefore the RDC multicasts a Service Discovery Join message 21 to a preconfigured multicast address. The message is a resource discovery subscription request. The RDS receives the Service Discovery Join message and processes it. The RDS determines from the Service Discovery Join message whether the RDS has pared with the RDC previously. If it has not, then the RDS sends information gathered from the Service Discovery Join message, such as the VLAN, source MAC, and source IP address, in a Service Binding Request message 22 sent to the RMS 12. For illustrative purposes, it is assumed that the VLAN, source MAC, and IP address are considered unique keys to identify a service binding.

If the RMS 12 is able to match a service binding with the values received in the Service Binding Request message 22, the RMS sends a Service Binding Reply message 23 to the RDS 13 with a unique service binding identifier or a simple acknowledgement if the sent information can be used later as identifiers. If necessary, the RDS may check policies at 24 to verify that the RDC 14 is permitted to subscribe to the resource discovery service. If the RDC is permitted to subscribe to the resource discovery service, then the RDS unicasts a Join Accept message 25 to the requesting RDC using the source IP address from the Service Discovery Join message 21. The process of pairing the RDC process is completed when the RDC receives the Join Accept message. The RDC is then aware of the IP address of the paired RDS and is able to send unicast requests to it in the future.

The discovery process may include identifying the services that are available to the user device 11. The discovered information may include the service type, the duration of service, the minimum delay requirements, the distributor of the service, and the like. This information in combination with information about the resources allocated to the specific services is utilized by the RDC to efficiently manage and monitor the resources.

For example, assuming that a VOIP service is utilized, the RDS 13 may send to the requesting RDC 14, a Join Accept message 25 that includes service information such as:
Distributor: telia.se
Service type: voip
Codec: ITU G.723
Min delay: 10 ms
Bit rate: 6.4 kbps

The Join Accept message 25 may also include resource information such as:
VLAN: 123
Bandwidth: 1 Mbps
Delay: 5 ms
Max CRC: 4

Thus, both the service information and the resources that are allocated to the service may be obtained through the discovery message process.

Alternatively, after obtaining the service information in the Join Accept message 25, the RDC 14 may send a Resource Request message 26 to the RDS 13 requesting resource information. Upon receiving the Resource Request message, the RDS may determine whether the service binding information is already stored locally. If it is not, then the RDS sends a Service Binding Attribute Request message 27 to the RMS 12. The RMS sends a Service Binding Attribute Reply message 28 to the RDS with the current values of the service bindings. The RDS parses and formats the Service Binding Attribute Reply message to create a Resource Reply message 29, which it sends to the paired RDC.

The present invention enables devices in the customer premises to obtain information regarding subscribed resources, and to obtain service assurance information indicating whether or not a service provider is in compliance with an applicable SLA. It also provides application developers with mechanisms to develop advanced logic within applications that will allow the applications to more efficiently utilize and take advantage of a customer's subscribed service resources. For example, the invention enables an application to select a proper codec for media streaming or sending information to a peer in order to provide optimal use of upstream and downstream resources.

The present invention also provides a non-intrusive mechanism for customer devices to become aware of available subscribed resources and whether other devices are sharing those resources.

From the operator point of view, the RDS 13 ensures that customers are not able to cheat, manipulate, or influence their service subscriptions using the information exchanged. The invention gives operators a value-added service that they can add to their product portfolio, and it is simple to integrate with preexisting resource management systems.

Those skilled in the art will readily appreciate that the present invention may be implemented using either hardware, or software, or both, and further, software implementations may vary using different languages and data structures. The present invention is not limited to a specific language and/or class of languages, nor is it limited to any single data structure implantation.

The present invention may of course, be carried out in other specific ways than those herein set forth without departing from the essential characteristics of the invention. The present embodiments are, therefore, to be considered in all respects as illustrative and not restrictive and all changes coming within the meaning and equivalency range of the appended claims are intended to be embraced therein.

1. A system for providing an end-user network with information regarding access network resources allocated to specific services, wherein the access network includes a Resource Management System, RMS, for managing service bindings in the access network, said system comprising:
a Resource Discovery Client, RDC, associated with the end-user network for sending a resource discovery request to the access network;
a Resource Discovery Server, RDS, associated with the access network, said RDS comprising:
means for receiving the resource discovery request from the RDC;
means for obtaining service binding information from the RMS, said service binding information indicating access network resources that are allocated to specific services; and
means for sending a response to the RDC, the response including the information regarding access network resources allocated to specific services.

2. The system according to claim 1, wherein the RDC is communicably connected to a user device in the end-user network, and the RDC includes means for sending to the user device, information regarding available access network resources.

3. The system according to claim 1, wherein the RDC includes means for discovering and authenticating the RDS.

4. The system according to claim 3, wherein the means for discovering and authenticating the RDS includes means for multicasting a resource discovery subscription request to a preconfigured multicast address.

5. The system according to claim 1, wherein the RDS also includes means for storing the service binding information obtained from the RMS, wherein if additional requests are received from the RDC for the same information, the RDS responds to the RDC without communicating with the RMS.

6. The system according to claim 1, further comprising a Resource Discovery Interface, RDI, for connecting the RDC and the RDS, wherein the RDI utilizes multicast messages to manage server discovery, and utilizes unicast messages to handle information requests and responses between the RDC and the RDS.

7. The system according to claim 1, wherein the means within the RDS for sending a response to the RDC includes means for sending to the RDC, both service information and allocated resource information in a single message.

8. The system according to claim 1, wherein the means within the RDS for sending a response to the RDC includes means for sending a first response message to the RDC establishing a pairing between the RDC and the RDS, and for sending a second response message in response to a resource request from the RDC, said second response message including the information regarding access network resources allocated to specific services.

9. A method of providing an end-user network with information regarding access network resources allocated to specific services, wherein the access network includes a Resource Management System, RMS, for managing service bindings in the access network, said method comprising:
receiving by a Resource Discovery Server, RDS, associated with the access network, a resource discovery request from a Resource Discovery Client, RDC, associated with the end-user network;
obtaining by the RDS, service binding information from the RMS, said service binding information indicating access network resources that are allocated to specific services; and
sending a response from the RDS to the RDC, the response including the information regarding access network resources allocated to specific services.

10. The method according to claim 9, further comprising sending information regarding available access network resources from the RDC to the user device.

11. The method according to claim 9, further comprising storing in the RDS, the service binding information obtained from the RMS, wherein if additional requests are received from the RDC for the same information, the RDS responds to the RDC without communicating with the RMS.

12. The method according to claim 9, wherein the receiving and sending steps are performed over a Resource Discovery Interface, RDI, for connecting the RDC and the RDS, wherein the RDI utilizes multicast messages to manage server discovery, and utilizes unicast messages to handle information requests and responses between the RDC and the RDS.

13. The method according to claim 9, wherein the step of sending a response from the RDS to the RDC includes sending to the RDC, both service information and allocated resource information in a single message.

14. The method according to claim 9, wherein the step of sending a response from the RDS to the RDC includes:
sending a first response message to the RDC establishing a pairing between the RDC and the RDS; and
sending a second response message in response to a resource request from the RDC, said second response message including the information regarding access network resources allocated to specific services.

15. A Resource Discovery Server, RDS, associated with an access network for providing an end-user network with information regarding access network resources allocated to specific services, wherein the access network includes a Resource Management System, RMS, for managing service bindings in the access network, said RDS comprising:
means for receiving a resource discovery request from a Resource Discovery Client, RDC, associated with the end-user network;
means for obtaining service binding information from the RMS, said service binding information indicating access network resources that are allocated to specific services; and
means for sending a response to the RDC, the response including the information regarding access network resources allocated to specific services.

16. The RDS according to claim 15, further comprising means for storing the service binding information obtained from the RMS, wherein if additional requests are received from the RDC for the same information, the RDS responds to the RDC without communicating with the RMS.

17. The RDS according to claim 15, wherein the means for receiving and the means for sending include a Resource Discovery Interface, RDI, for connecting the RDC and the RDS, wherein the RDI utilizes multicast messages to manage server discovery, and utilizes unicast messages to handle information requests and responses between the RDC and the RDS.

18. The RDS according to claim 15, wherein the means for sending a response to the RDC includes means for sending to the RDC, both service information and allocated resource information in a single message.

19. The RDS according to claim 15, wherein the means for sending a response to the RDC includes means for sending a first response message to the RDC establishing a pairing between the RDC and the RDS, and for sending a second response message in response to a resource request from the RDC, said second response message including the information regarding access network resources allocated to specific services.
